(19) United States
(12) Patent Application Publication
(10) Pub. No.: US 2002/0024270 A1
(43) Pub. Date: Feb. 28, 2002

(54) Piezoelectric/electrostrictive film element formed at low temperature using electrophoretic deposition

(75) Inventors: Sang Kyeong Yun, Suwon-Shi (KR); Dong Hoon Kim, Suwon-Shi (KR)

Correspondence Address: DARBY & DARBY P.C., 805 Third Avenue, New York, NY, 10022, US

(73) Assignee: SUMSUNG ELECTRO-MECHANICS CO.

(21) Appl. No.: 09/975,834

(22) Filed: Oct. 11, 2001

Related U.S. Application Data
(62) Division of application No. 09/417,415, filed on Oct. 13, 1999.

(30) Foreign Application Priority Data
Oct. 14, 1998 (KR) 1998-42911
Jul. 6, 1999 (KR) 1999-27080

(51) Int. Cl. H04R 17/00; H02N 2/00

(52) U.S. Cl. 310/323.11; 29/25.35; 310/311

(57) ABSTRACT

The present invention relates to a method for forming piezoelectric/electrostrictive film element at low temperature using electrophoretic deposition, the method comprising the steps of: preparing a solution or a dispersed mixture containing constituent ceramic elements by dissolving or dispersing the raw material of constituent ceramic elements in a solvent or a dispersion medium; preparing a mixed solution by adding citric acid into the solution or the dispersed mixture in which the constituent ceramic elements are dissolved or dispersed; getting ultrafine ceramic oxide powder of particle size less than 1 μm with uniform particle diameter size distribution by forming ceramic oxide without scattering over, by nonexplosive oxidative reductive combustion reaction by thermally treating the mixed solution at 100-500° C.; preparing a suspension by dispersing the ultrafine ceramic oxide powder in an organic dispersant; preparing ceramic sol solution by dissolving constituent ceramic elements of same or similar constituent with the ultrafine ceramic oxide powder in water or an organic solvent; dispersing by mixing the suspension in which the ultrafine ceramic oxide powder is dispersed with the ceramic sol solution; forming a piezoelectric/electrostrictive film element by submerging a substrate into the suspension which the ultrafine ceramic oxide powder and the ceramic sol solution are mixed and then by performing electrophoretic deposition; and thermally treating the piezoelectric/electrostrictive film element at 100-600° C. Also the present invention relates to a piezoelectric/electrostrictive film element produced by the method. Whose advantageous effects are that energy required for electrophoretic deposition process is reduced and piezoelectric/electrostrictive film element can be formed where stacking status of particles is very dense even only with low temperature treatment.

### BACKGROUND OF THE INVENTION

1. Field of the Invention

The present invention relates to a method for forming piezoelectric/electrostrictive film element using an ultrafine ceramic oxide powder and the electrophoretic deposition, and piezoelectric/electrostrictive film element produced by the method. In particular, the present invention relates to a method for forming a piezoelectric/electrostrictive film element at low temperature by way of electrophoretic deposition method using an ultrafine ceramic oxide powder having excellent reactivity and produced by a single process at low temperature, and the piezoelectric/electrostrictive film element produced by the method.

2. Description of the Prior Art

Unit particle micronization and particle diameter distribution uniformalization etc. are emphasized in ceramic oxide powder which is raw material of various devices using the ceramics such as ink jet head, memory chip, and piezoelectric substance, because in case of finer particles the activation energy can be lowered by surface treatment and the reactivity and applicability can be improved by particle electrification.

So far the method has been used where a ceramic sol controlled of viscosity or a ceramic oxide powder regenerated by a suitable solvent is fixed at the substrate in order to form a piezoelectric/electrostrictive film element in manufacturing method of various film devices using the ceramics.

Considering ultimately obtained film quality, methods mainly used for the ceramic sol solution are dip coating, spin coating, electrochemical oxidation/reduction etc. while methods used for the ceramic oxide powder are various printing, molding, electrophoretic deposition (EPD) etc.

Among these methods, EPD is a method to mold an elaborate film using the polarization of each component by electric polarity and the stacking property of solid particles.

In the EPD process using a ceramic oxide powder in FIG. 2, ceramic particles of average diameter not less than 1 μm made by solid phase process are dispersed in adequate dispersion medium of water or organic dispersant, then they are mixed with a pH-controlling medium to make a sol solution controlled of surface electric charge, which the colloidal suspension is used for ceramic to move to cathode or anode to form a film on substrate which film is vapor deposited by thermal treatment above 1000° C. eventually to form the film.

EPD like this has advantage to make a high quality film unrestricted of area or thickness using a simple equipment.

But there needs a separate operation to disperse powder using a dispersant in order to secure dispersibility because large particle diameter powder is used; and there is inevitability problem of high temperature thermal treatment to get material property peculiar of ceramic because formed film property is similar to bulk.

### SUMMARY OF THE INVENTION

The present invention to solve the problems has purpose of firstly a method to form a piezoelectric/electrostrictive film element through electrophoretic deposition and thermal treatment at low temperature using ultrafine ceramic oxide powder which is very excellent in reactivity as well as it is very fine in particle size as it has been made by single process at low temperature by combustion method using the citric acid as a combustion aid and of secondly the provision and supply of piezoelectric/electrostrictive film element formed by the method at low temperature.

The present invention to achieve the purpose features a method for forming piezoelectric/electrostrictive film element at low temperature using electrophoretic deposition, the method comprising the steps of : preparing a solution or a dispersed mixture containing constituent ceramic elements by dissolving or dispersing the raw material of constituent ceramic elements in a solvent or a dispersion medium; preparing a mixed solution by adding citric acid into the solution or the dispersed mixture in which the constituent ceramic elements are dissolved or dispersed; getting ultrafine ceramic oxide powder of particle size less than 1 μm with uniform particle diameter size distribution by forming ceramic oxide without scattering over, by nonexplosive oxidative-reductive combustion reaction by thermally treating the mixed solution at 100-500° C.; preparing a suspension by dispersing the ultrafine ceramic oxide powder in an organic dispersant; preparing ceramic sol solution by dissolving constituent ceramic elements of same or similar constituent with the ultrafine ceramic oxide powder in water or an organic solvent; dispersing by mixing the suspension in which the ultrafine ceramic oxide powder is dispersed with the ceramic sol solution; forming a piezoelectric/electrostrictive film element by submerging a substrate into the suspension which the ultrafine ceramic oxide powder and the ceramic sol solution are mixed and then by performing electrophoretic deposition; and thermally treating the piezoelectric/electrostrictive film element at 100-600° C., so that the solvent is removed by the thermal treatment and the bonding among the ultrafine ceramic oxide powder particles is induced while the ceramic sol acts as a reaction medium on the surfaces of the ceramic oxide particles.

Also the present invention features a piezoelectric/electrostrictive film element produced by a method comprising the steps of preparing a solution or a dispersed mixture containing constituent ceramic elements by dissolving or dispersing the raw material of constituent ceramic elements in a solvent or dispersion medium; preparing a mixed solution by adding citric acid into the solution or the dispersed mixture in which the constituent ceramic elements are dissolved or dispersed; getting ultrafine ceramic oxide powder of particle size less than 1 μm with uniform particle diameter size distribution by forming ceramic oxide without scattering over, by nonexplosive oxidative-reductive combustion reaction by thermally treating the mixed solution at 100-500° C.; preparing a suspension by dispersing the ultrafine ceramic oxide powder in an organic dispersant; preparing ceramic sol solution by dissolving constituent ceramic elements of same or similar constituent with the ultrafine ceramic oxide powder in water or an organic solvent; dispersing by mixing the suspension in which the ultrafine ceramic oxide powder is dispersed with the ceramic sol solution; forming a piezoelectric/electrostrictive film element by submerging a substrate into the suspension which the ultrafine ceramic oxide powder and the ceramic sol solution are mixed and then by performing electrophoretic deposition; and thermally treating the piezoelectric/electrostrictive film element at 100-600° C., so that the solvent is removed by the thermal treatment and the bonding among the ultrafine ceramic oxide powder particles is induced while the ceramic sol acts as a reaction medium on the surfaces of the ceramic oxide particles.

### BRIEF DESCRIPTION OF THE DRAWINGS

FIG. 1 is a flow diagram producing method of ultrafine ceramic oxide powder used in the present invention.

FIG. 2 is a flow diagram of forming process of piezoelectric/electrostrictive film element using the conventional electrophoretic deposition.

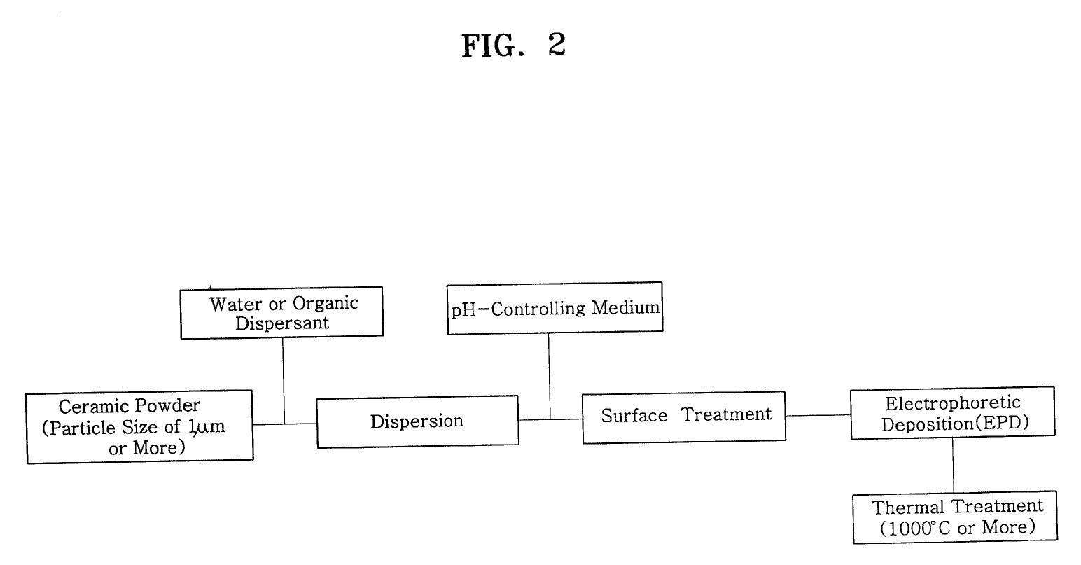

FIG. 3 is a flow diagram of a method for forming a piezoelectric/electrostrictive film element using the electrophoretic deposition at low temperature according to the present invention.

### DETAIL DESCRIPTION

The present invention will be explained in detail.

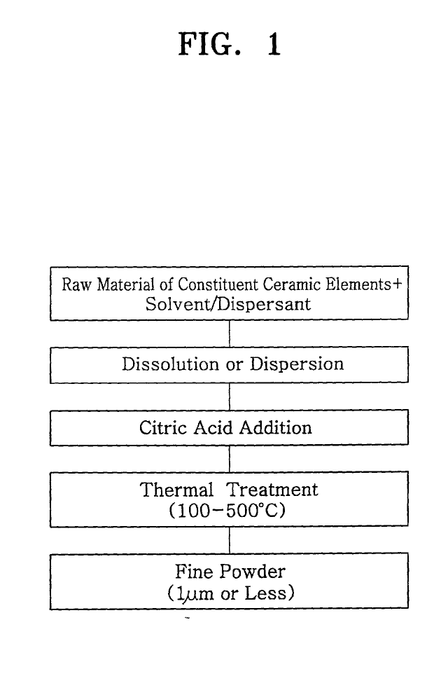

First, a method for producing a ultrafine ceramic oxide powder used as a raw material in piezoelectric/electrostrictive film element producing according to the present invention as in a flow diagram of FIG. 1 will be explained.

A ultrafine ceramic oxide powder producing method of the present invention comprises the steps of: sufficiently dissolving or uniformly dispersing the raw material of constituent ceramic elements in solvent or dispersant to make a solution or a dispersion mixture containing the constituent ceramic elements; adding, into the solution or the dispersion mixture containing the constituent ceramic elements, citric acid in no less than the required amount to give rise to oxidative-reductive combustion reaction with an anion of the ceramic constituent ceramic element so as to make a mixed solution; and thermally treating the mixed liquid at 100-500° C. But it may additionally further comprises a step of conducting additional thermal treatment at 700-900° C. to increase crystallinity.

As for the raw material containing the constituent ceramic elements, use is made of from among oxide, carbonate, nitrate etc. of constituent ceramic element, its salt with organics or inorganics, or constituent ceramic elements complex.

As for the constituent ceramic element, it is preferable to use a piezoelectric/electrostrictive ceramic element comprising lead (Pb) and titanium (Ti) as basic constituent elements.

Especially as for the constituent ceramic element, it is preferable to use that composed of elements including lead (Pb), zirconium (Zr) and titanium (Ti), or lead (Pb), zirconium (Zr), titanium (Ti)/lead (Pb), magnesium (Mg), niobium (Nb).

As for the solvent or the dispersant to dissolve or disperse the raw material of constituent ceramic elements, one or more are selected to use from among water and organic solvents that can dissolve or disperse the raw material containing the constituent ceramic elements. As for the organic solvents, mainly acetic acid, dimethyl formamide, methoxyethanol, alcohols, glycols etc. are used.

As for the combustion aid, citric acid is used, which is an organic compound that can give rise to combustion reaction. In the conventional method, the citric acid has been used not as a combustion aid but a complexing agent in order to give reaction uniformity and has bee used in process such as Pechini process, where speed-controlled combustion reaction can be induced using citric acid's flammability and complex formation effect.

A mixture is made by adding citric acid into a solution or a dispersed mixture where constituent ceramic elements are dissolved or dispersed. The quantity of the citric acid added shall not be less than the necessary amount to give rise to oxidative-reductive combustion reaction with the anion of the constituent ceramic element. Reaction speed can be controlled by the quantity of citric acid added.

The mixture made by the addition of the citric acid is thermally treated at 100-500° C. Though the crystallinity of the ceramic phase increases as the temperature for the thermal treatment, the citric acid combustion reaction may start enough if only temperature for the thermal treatment is over 100° C. And though reaction can arise even if the temperature for the thermal treatment is above 500° C., thermally treating above that temperature is meaningless when comparing with the conventional method.

More preferably it shall be thermally treated at 150-300° C. which is a temperature range can secure suitably the crystallinity of the ceramic phase although it is considerably low temperature range for a thermal treatment.

If the mixture is thermally treated to vaporize the solvent or the dispersant, the added citric acid acts as a reductive combustion aid and is removed giving rise to nonexplosive oxidative-reductive combustion reaction with the anion of constituent ceramic element, when the ceramic oxide is formed without scattering out by virtue of reaction heat generated at this time.

And in the reaction, components other than the constituent ceramic element are removed during sufficient time of combustion reaction so that the ultrafine ceramic oxide powder of pure type without impurity is obtained.

The particle size of the ultrafine ceramic oxide powder obtained by the method is below 1 μm, and is specifically 0.0-10.1 μm so extremely fine with uniform powder particle diameter distribution. The primary particles of which powder exist as independent bodies or as a soft aggregate type, and are in completely burnt ceramic phase so that the weight does not decrease even by additional thermal treatment.

And because the powder has excellent surface reactivity so that molding is feasible even only with a thermal treatment at low temperature, the degree of freedom for a vibration plate is high and diverse methods of printing and coating can be applied.

But it may additionally comprises a step of conducting additional thermal treatment of the obtained ultrafine ceramic oxide powder at 700-900° C. to increase the crystallinity of the powder produced.

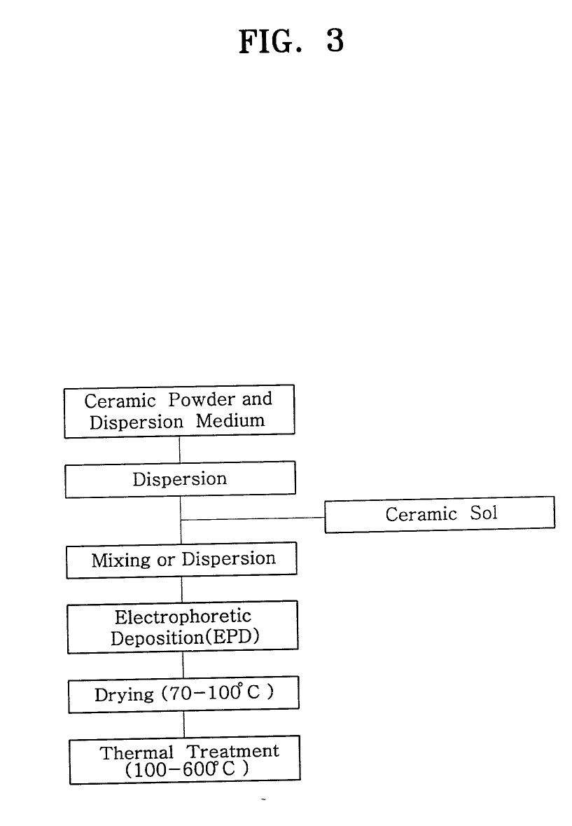

A method for forming a piezoelectric/electrostrictive film element at low temperature by electrophoretic deposition process using ultrafine ceramic oxide powder will be explained. FIG. 3 shows a method for forming a piezoelectric/electrostrictive film element at low temperature by electrophoretic deposition process.

As for the ceramic oxide powder, the ultrafine ceramic oxide powder obtained by the method is used because it is effective to use fine powder to secure system feasible of forming at low temperature considering the powder reactivity itself.

The ultrafine ceramic oxide powder produced has small ceramic particle size with uniform size distribution and no voids so that it can get ideal stacking result with maximum bonding strength between particles.

Whence it is preferable to use PZT, PMN or their solid solution (PZT-PMN) complex oxides as for the ultrafine ceramic oxide powder.

And the ultrafine ceramic oxide powder may additionally comprises one or more components among nickel (Ni), lanthanum (La), barium (Ba), zinc (Zn), lithium (Li), cobalt (Co), cadmium (Cd), cerium (Ce), chromium (Cr), antimony (Sb), iron (Fe), yttrium (Y), tantalum (Ta), tungsten (W), strontium (Sr), calcium (Ca), bismuth (Bi), tin (Sn) and manganese (Mn). Because interparticle vacancy exists no matter how closely it approaches ideal stacking state, in order to improve density problem occurring according to the interparticle vacancy, here are separately prepared a suspension or a dispersion liquid dispersed of the ultrafine ceramic oxide powder in an organic dispersant and a ceramic sol solution having same or similar composition with the ultrafine ceramic oxide powder.

The ultrafine ceramic oxide powder is used dispersed in an organic dispersant as for which is mainly used alcohols such as ethanol and methoxy ethanol, and acetones such as acetone and acetyl acetone.

It is preferable that the content of the organic dispersant is 1-500 ml per gram of the ultrafine ceramic oxide powder. It is because adequate dispersion does not arise if the content of the organic dispersant is lower than 1 ml per gram of the ultrafine ceramic oxide powder while if the content is higher than 500 ml per gram of the ultrafine ceramic oxide powder then the oxide powder is diluted to be of exceedingly low viscosity.

The ceramic sol solution is made based on water or organic solvent which can be used from among a variety of organic solvents but is preferable to be mainly acetic acid, dimethyl formamide, methoxyethanol, alcohols, glycols etc.

Then the ceramic sol solution and the suspension of the ultrafine ceramic oxide powder which are prepared separately are mixed. The mixing ratio of the ultrafine ceramic oxide powder and the ceramic sol solution may be preferable if the content of the ceramic sol solution is 1-500 parts by weight based on the weight of the ultrafine ceramic oxide powder when the powder and the suspension are mixed.

Thus if the ultrafine ceramic oxide powder and the ceramic sol solution are mixed, the most of voids occurred after stacking is filled by the ceramic sol and the sol is transferred to ceramic particles during thermal treatment process after the film formation so that voids substantially decrease.

And as the ceramic sol itself has electric charge and is compatible with both the ultrafine ceramic oxide powder and the solvent, it is feasible of stabilization of the suspension and the surface electricity charge treatment of the ultrafine ceramic oxide powder even without separate operation and pH control medium.

If a work electrode attached of substrate and an opposite electrode dip into sol solution mixed of the ultrafine ceramic oxide powder and the ceramic sol solution, the ceramic sol and the ultrafine ceramic oxide powder polarized in the sol solution phase move to the work electrode to form a film on the substrate attached at the work electrode.

Metal, resinous polymeric organic compound, or ceramics may be used as a vibration plate.

As for the metal for the vibrating plate, nickel (Ni) or stainless steel is mainly used; as for the resinous polymeric organic compound, polyester, polyimide, or teflon resin is mainly used; and as for the ceramics, alumina (Al₂O₃), zirconia (ZrO₂), silicon (Si), silicon carbide (SiC), silicon nitride (Si₃N₄), silicon dioxide (SiO₂), or glasses is mainly used.

At this time, it may be postfinished after generally forming the film on substrate, or screen, mold, or mask might be set on the substrate so as to form a piezoelectric/electrostrictive film element of desired type.

Whence it is preferable to form the piezoelectric/electrostrictive film element in the thickness of 1-100 μm, and may be more preferable to form in the thickness of 5-30 μm.

The formed piezoelectric/electrostrictive film is thermally treated to remove the remaining solvent and convert the contained sol into fine ceramic particles. Thus the solvent is removed by thermal treatment and the ceramic sol acts as a reaction medium on oxide particle surface to induce the bonding between ultrafine ceramic oxide particles.

The reason for the reaction is sufficient only by the thermal treatment at the low temperature of 100-600° C. is that a reaction same as a sintering may take place by mutual reaction of bonding between the ultrafine ceramic oxide powder and the raw material of the constituent ceramic elements in the ceramic sol solution. And so the added organic materials are removed during the thermal treatment.

Specifically in case of the polymeric organic compound, because the substrate may be damaged if thermally treated above 500° C., it is preferable to thermally treat it at 100-300° C. in case where the polymeric organic compound is used as a substrate.

So more preferably thermal treatment may be conducted at 150-300° C., which temperature range can suitably secure the crystallinity and formability of the piezoelectric/electrostrictive film element even as the range is for the thermal treatment at considerably low temperature.

And the method mat further comprise a step of drying the formed piezoelectric/electrostrictive film element before the thermal treatment after forming the piezoelectric/electrostrictive film element, whence it is preferable to dry the piezoelectric/electrostrictive film element at 70-100° C.

The piezoelectric/electrostrictive film element obtained by the method is excellent in characteristics proper of ceramics though the element has been thermally treated at low temperature.

So as for the present invention as above, energy required for electrophoretic deposition process is reduced because the ultrafine ceramic oxide powder is used and there is a low energization effect of the producing method because the piezoelectric/electrostrictive film element can be formed where the stacking status of the particles is very dense even only with the thermal treatment at low temperature.

Now the present invention will be explained in detail by the following practical examples. But the following application examples are only illustrations of the present invention and do not confine the extent of the present invention.

### EXAMPLE 1

1 g of fine powder PZT-PMN was added into methoxyethanol 300 ml and acetyl acetone 20 ml, and 1 g of PZT sol was added into the mixed solution,. Then it was dispersed for 30 minutes by a ultrasonic generator. Afterwards it was agitated by a magnetic stirrer.

A SUS 316L plate fixed of silicon substrate and mask was prepared as a work electrode and a SUS plate of same area was prepared as an opposite charge electrode. The electrodes were put into the suspension and were connected to electric supply to proceed electrophoretic deposition at 70 V and 0.03 A for 10 minutes.

The work electrode completed of vapor deposition was withdrawn, the substrate was separated from the SUS plate, and the mask was removed.

The substrate where a pattern had been formed was thermally treated at 100° C. in a chamber and was dried, which was then thermally treated at 300° C., 2 hr. Then aluminum was vapor deposited as an upper electrode, and electric potential was added to measure the displacement of the substrate (vibration plate) by piezoelectric phenomenon.

The piezoelectric characteristics represented by the displacement of the vibration plate was more excellent than that of a piezoelectric/electrostrictive film element produced by the conventional method.

### EXAMPLE 2

1 g of fine powder PZT-PMN was added into methoxyethanol 300 ml and acetyl acetone 100 ml, and into which mixed solution, 4 g of PZT sol was added. Then it was dispersed for 30 minutes by a untrasonic generator. Afterwards it was agitated by a magnetic stirrer.

A SUS 316L plate fixed of nickel substrate and mask was prepared as a work electrode and a SUS plate of same area was prepared as an opposite charge electrode. Then the electrodes were put into the suspension and were connected to electric supply to proceed electrophoretic deposition at 70 V and 0.03 A for 10 minutes.

The work electrode completed of vapor deposition was withdrawn, the substrate was separated from SUS plate, and the mask was removed.

A substrate where pattern had been formed was thermally treated at 70° C. in a chamber and was dried, which was then thermally treated at 300° C., 2 hr. Then gold was vapor deposited as an upper electrode, and electric potential was added to measure the displacement of the substrate (vibration plate) by piezoelectric phenomenon.

Piezoelectric characteristics represented by the displacement of the vibration plate was more excellent than that of a piezoelectric/electrostrictive film element produced by the conventional method.

What is claimed is:

1. Method for forming piezoelectric/electrostrictive film element at low temperature using electrophoretic deposition, the method comprising the steps of:
A) preparing a solution or a dispersed mixture containing constituent ceramic elements by dissolving or dispersing the raw material of constituent ceramic elements in a solvent or a dispersion medium;
B) preparing a mixed solution by adding citric acid into said solution or said dispersed mixture in which said constituent ceramic elements are dissolved or dispersed;
C) getting ultrafine ceramic oxide powder of particle size less than 1 μm with uniform particle diameter size distribution by forming ceramic oxide without scattering over, by nonexplosive oxidative-reductive combustion reaction by thermally treating said mixed solution at 100-500° C.;
D) preparing a suspension by dispersing said ultrafine ceramic oxide powder in an organic dispersant;
E) preparing ceramic sol solution by dissolving constituent ceramic elements of same or similar constituent with said ultrafine ceramic oxide powder in water or an organic solvent;
F) dispersing by mixing said suspension in which said ultrafine ceramic oxide powder is dispersed with said ceramic sol solution;
G) forming a piezoelectric/electrostrictive film element by submerging a substrate into said suspension which said ultrafine ceramic oxide powder and said ceramic sol solution are mixed and then by performing electrophoretic deposition; and
H) thermally treating said piezoelectric/electrostrictive film element at 100-600° C.,
so that said solvent is removed by said thermal treatment and the bonding among said ultrafine ceramic oxide powder particles is induced while said ceramic sol acts as a reaction medium on the surfaces of said ceramic oxide particles.

2. The method in claim 1, further comprising the step of:
thermally treating said ultrafine ceramic oxide powder at 700-900° C. before D).

3. The method in claim 1 or claim 2, further comprising the step of:
drying said piezoelectric/electrostrictive film between G) and H).

4. The method in claim 3, wherein said piezoelectric/electrostrictive film is dried at 70-100° C.

5. The method in claim 1 or claim 2, wherein the particle size of said ultrafine ceramic oxide powder is 0.01-0.1 μm.

6. The method in claim 1, wherein said substrate is made of metal, resinous polymeric organic compound, or ceramic.

7. The method in claim 6, wherein said metal is nickel (Ni) or stainless steel.

8. The method in claim 6, wherein said resinous polymeric organic compound is polyester, polyimide, or teflon-based resin.

9. The method in claim 6, wherein said ceramic is alumina (Al₂O₃), zirconia (ZrO₂), silicon (Si), silicon carbide (SiC), silicon nitride (Si₃N₄), silicon dioxide (SiO₂), or glasses.

10. The method in claim 1, wherein said ultrafine ceramic oxide includes lead (Pb), zirconium (Zr) and titanium (Ti).

11. The method in claim 10, wherein said ultrafine ceramic oxide is PZT, PMN or their solid solution (PZT-PMN) complex oxide.

12. The method in claim 11, wherein said ceramic oxide powder further includes one or more element among nickel (Ni), lanthanum (La), barium (Ba), zinc (Zn), lithium (Li), cobalt (Co), cadmium (Cd), cerium (Ce), chromium (Cr), antimony (Sb), iron (Fe), yttrium (Y), tantalum (Ta), tungsten (W), strontium (Sr), calcium (Ca), bismuth (Bi), tin (Sn) and manganese (Mn).

13. The method in claim 1, wherein said organic dispersion medium in which said ultrafine ceramic oxide powder is dispersed is alcohols or acetones.

14. The method in claim 1, wherein the content of said organic dispersant is 1-500 ml per gram of the ultrafine ceramic oxide powder which is dispersed.

15. The method in claim 1, wherein said organic solvent which is a base of said ceramic sol solution is acetic acid, dimethyl formamide, methoxyethanol, alcohols, or glycols.

16. The method in claim 1, wherein the content of said ceramic sol solution is 1-500 parts by weight based on the weight of said ceramic oxide powder when said suspension of said ultrafine ceramic oxide powder and said ceramic sol solution are mixed.

17. The method in claim 1, wherein the thickness of said piezoelectric/electrostrictive film element is 1-100 μm.

18. The method in claim 17, wherein the thickness of said piezoelectric/electrostrictive film element is 5-30 μm.

19. The method in claim 1, wherein said piezoelectric/electrostrictive film element is thermally treated at 150-300° C.

20. A piezoelectric/electrostrictive film element produced by a method comprising the steps of:
A) preparing a solution or a dispersed mixture containing constituent ceramic elements by dissolving or dispersing the raw material of constituent ceramic elements in a solvent or dispersion medium;
B) preparing a mixed solution by adding citric acid into said solution or said dispersed mixture in which said constituent ceramic elements are dissolved or dispersed;
C) getting ultrafine ceramic oxide powder of particle size less than 1 μm with uniform particle diameter size distribution by forming ceramic oxide without scattering over, by nonexplosive oxidative-reductive combustion reaction by thermally treating said mixed solution at 100-500° C.;
D) preparing a suspension by dispersing said ultrafine ceramic oxide powder in an organic dispersant;
E) preparing ceramic sol solution by dissolving constituent ceramic elements of same or similar constituent with said ultrafine ceramic oxide powder in water or an organic solvent;
F) dispersing by mixing said suspension in which said ultrafine ceramic oxide powder is dispersed with said ceramic sol solution;
G) forming a piezoelectric/electrostrictive film element by submerging a substrate into said suspension which said ultrafine ceramic oxide powder and said ceramic sol solution are mixed and then by performing electrophoretic deposition; and
H) thermally treating said piezoelectric/electrostrictive film element at 100-600° C.,
so that said solvent is removed by said thermal treatment and the bonding among said ultrafine ceramic oxide powder particles is induced while said ceramic sol acts as a reaction medium on the surfaces of said ceramic oxide particles.

21. The piezoelectric/electrostrictive film element in claim 20, wherein the method further comprises a step of thermally treating said ultrafine ceramic oxide powder at 700-900° C. before D).

22. The piezoelectric/electrostrictive film element in claim 20 or claim 21, wherein the method further comprises a step of drying said piezoelectric/electrostrictive film between G) and H).

23. The piezoelectric/electrostrictive film element in claim 22, wherein said piezoelectric/electrostrictive film is dried at 70-100° C.

24. The piezoelectric/electrostrictive film element in claim 20, wherein the particle size of said ultrafine ceramic oxide powder is 0.01-0.1 μm.

25. The piezoelectric/electrostrictive film element in claim 20, wherein said substrate is made of metal, resinous polymeric organic compound, or ceramic.

26. The piezoelectric/electrostrictive film element in claim 25, wherein said metal is nickel (Ni) or stainless steel.

27. The piezoelectric/electrostrictive film element in claim 25, wherein said resinous polymeric organic compound is polyester, polyimide, or teflon-based resin.

28. The piezoelectric/electrostrictive film element in claim 25, wherein said ceramic is alumina (Al₂O₃), zirconia (ZrO₂), silicon (Si), silicon carbide (SiC), silicon nitride (Si₃N₄), silicon dioxide (SiO₂), or glasses.

29. The piezoelectric/electrostrictive film element in claim 20, wherein said ultrafine ceramic oxide includes lead (Pb), zirconium (Zr) and titanium (Ti).

30. The piezoelectric/electrostrictive film element in claim 29, wherein said ultrafine ceramic oxide is PZT, PMN or their solid solution (PZT-PMN) complex oxide.

31. The piezoelectric/electrostrictive film element in claim 30, wherein said ceramic oxide powder further includes one or more element among nickel (Ni), lanthanum (La), barium (Ba), zinc (Zn), lithium (Li), cobalt (Co), cadmium (Cd), cerium (Ce), chromium (Cr), antimony (Sb), iron (Fe), yttrium (Y), tantalum (Ta), tungsten (W), strontium (Sr), calcium (Ca), bismuth (Bi), tin (Sn) and manganese (Mn).

32. The piezoelectric/electrostrictive film element in claim 20, wherein said organic dispersion medium in which said ultrafine ceramic oxide powder is dispersed is alcohols or acetones.

33. The piezoelectric/electrostrictive film element in claim 20, wherein the content of said organic dispersant is 1-500 ml per gram of the ultrafine ceramic oxide powder which is dispersed.

34. The piezoelectric/electrostrictive film element in claim 20, wherein said organic solvent which is a base of said ceramic sol solution is acetic acid, dimethyl formamide, methoxyethanol, alcohols, or glycols.

35. The piezoelectric/electrostrictive film element in claim 20, wherein the content of said ceramic sol solution is 1-500 parts by weight based on the weight of said ceramic oxide powder when the suspension of said ultrafine ceramic oxide powder and said ceramic sol solution are mixed.

36. The piezoelectric/electrostrictive film element in claim 20, wherein the thickness of said piezoelectric/electrostrictive film element is 1-100 μm.

37. The piezoelectric/electrostrictive film element in claim 36, wherein the thickness of said piezoelectric/electrostrictive film element is 5-30 μm.

38. The piezoelectric/electrostrictive film element in claim 20, wherein said piezoelectric/electrostrictive film element is thermally thermaled at 150-300° C.

39. A piezoelectric/electrostrictive film produced by the steps of:
A) preparing ceramic oxide powder by a non-explosive oxidative-reductive combustion reaction at a low temperature of 100-500° C., said ceramic oxide powder having a grain size of 1 μm or less and including lead (Pb) and titanium (Ti) as its basic constituents;
B) preparing ceramic sol solution by using an organic solvent or water as a base, said ceramic sol solution having constituents which are identical or similar to those of said ceramic oxide powder;
C) preparing suspension by dispersing said ultrafine ceramic powder into an organic dispersive medium;
D) obtaining dispersive mixture by mixing said suspension with said ceramic sol solution;
E) producing the piezoelectric/electrostrictive film by dipping a substrate into said dispersive mixture, and then performing electrophoretic deposition; and
E) thermally treating said piezoelectric/electrostrictive film at a temperature of 100-600° C., thereby removing said solvent, said ceramic sol solution serving as a reaction medium on the surfaces of ceramic oxide powder so that said oxide powder are coupled together.

40. The piezoelectric/electrostrictive film element in claim 39, wherein the method further comprises a step of thermally treating said ultrafine ceramic oxide powder at 700-900° C. before D).

41. The piezoelectric/electrostrictive film element in claim 39 or claim 40, wherein the method further comprises a step of drying the piezoelectric/electrostrictive film between G) and H).

42. The piezoelectric/electrostrictive film element in claim 41, wherein the piezoelectric/electrostrictive film is dried at 70-100° C.

43. The piezoelectric/electrostrictive film element in claim 39, wherein the particle size of said ultrafine ceramic oxide powder is 0.01-0.1 μm.

44. The piezoelectric/electrostrictive film element in claim 39, Wherein said substrate is made of metal, resinous polymeric organic compound, or ceramics.

45. The piezoelectric/electrostrictive film element in claim 44, wherein said metal is nickel or stainless steel.

46. The piezoelectric/electrostrictive film element in claim 44, wherein said resinous polymeric organic compound is polyester, polyimide, or teflon-based resin.

47. The piezoelectric/electrostrictive film element in claim 44, wherein said ceramic is alumina, zirconia, silicon, silicon carbide, silicon nitride, silicon dioxide, or glasses.

48. The piezoelectric/electrostrictive film element in claim 39, wherein said ultrafine ceramic oxide includes lead (Pb), zirconium (Zr) and titanium (Ti).

49. The piezoelectric/electrostrictive film element in claim 48, wherein said ultrafine ceramic oxide is PZT, PMN or their solid solution (PZT-PMN) complex oxide.

50. The piezoelectric/electrostrictive film element in claim 49, wherein said ceramic oxide powder further includes one or more elements among nickel (Ni), lanthanum (La), barium (Ba), zinc (Zn), lithium (Li), cobalt (Co), cadmium (Cd), cerium (Ce), chromium (Cr), antimony (Sb), iron (Fe), yttrium (Y), tantalum (Ta), tungsten (W), strontium (Sr), calcium (Ca), bismuth (Bi), tin (Sn) and manganese (Mn).

51. The piezoelectric/electrostrictive film element in claim 39, wherein said organic dispersion medium in which said ultrafine ceramic oxide is dispersed is alcohols or acetones.

52. The piezoelectric/electrostrictive film element in claim 39, wherein the content of said organic dispersant is 1-500 ml per gram of the ultrafine ceramic oxide powder which is dispersed.

53. The piezoelectric/electrostrictive film element in claim 39, wherein said organic solvent which is a base of said ceramic sol solution is acetic acid, dimethyl formamide, methoxyethanol, alcohols, or glycols.

54. The piezoelectric/electrostrictive film element in claim 39, wherein the content of said ceramic sol solution is 1-500 parts by weight based on the weight of said ceramic oxide powder when the suspension of said ultrafine ceramic oxide powder and said ceramic sol solution are mixed.

55. The piezoelectric/electrostrictive film element in claim 39, wherein the thickness of said piezoelectric/electrostrictive film element is 1-100 μm.

56. The piezoelectric/electrostrictive film element in claim 55, wherein the thickness of said piezoelectric/electrostrictive film element is 5-30 μm.

57. The piezoelectric/electrostrictive film element in claim 39, wherein said piezoelectric/electrostrictive film element is thermally thermaled at 150-300° C.
